(19) United States
(12) Patent Application Publication
(10) Pub. No.: US 2025/0153973 A1
(43) Pub. Date: May 15, 2025

(54) ELEVATOR EMERGENCY OPERATION DEVICE WITH SAFETY FUNCTION TEST

(71) Applicant: Otis Elevator Company, Farmington, CT (US)

(72) Inventors: Xingzhong Sun, Hangzhou (CN); Shan Li, Hangzhou (CN); Weilin Dai, Hangzhou (CN)

(21) Appl. No.: 18/937,213

(22) Filed: Nov. 5, 2024

(30) Foreign Application Priority Data
Nov. 10, 2023 (CN) 202311494965.6

(51) Int. Cl. B66B 5/00; B66B 1/34; B66B 5/06

(52) U.S. Cl. CPC B66B 5/0037; B66B 1/3492; B66B 5/06

(57) ABSTRACT

An elevator emergency operation device with safety function testing capability. The device includes a connection unit and a control unit. The connection unit includes a first connection component adapted to be connected with a car status detection device and a second connection component adapted to be connected with a holding brake controller. The control unit is connected with the connection unit and is configured to perform various operations. In one operation, an elevator emergency operation function is performed in a first configuration state in which the first connection component and the second connection component are connected with the car status detection device and the holding brake controller, respectively. In another operation, in the first configuration state, releasing a holding brake associated with the holding brake controller and determining whether a seal star function is normal based on a first car status signal provided by the car status detection device.

### FOREIGN PRIORITY

This application claims priority to Chinese Patent Application No. 202311494965.6, filed Nov. 10, 2023, and all the benefits accruing therefrom under 35 U.S.C. § 119, the contents of which in its entirety are herein incorporated by reference.

### TECHNICAL FIELD OF INVENTION

The present application relates to elevator technology and, in particular, to an elevator emergency operation device with safety function testing capability.

### BACKGROUND OF THE INVENTION

In an elevator system, when an emergency situation (e.g., an event such as an elevator malfunction, power failure, or fire, etc.) occurs in an elevator, an elevator emergency operation (EMRO) device will be activated. This device allows maintenance personnel or operators to safely control the operation of the elevator for rescue or evacuation without relying on normal elevator control functions. As an important safety function, the EMRO is usually mandated by laws and regulations to be equipped in the elevator system.

### SUMMARY OF THE INVENTION

In accordance with an aspect of the present application, there is provided an elevator emergency operation device with safety function testing capability, the device comprising a connection unit and a control unit. The connection unit comprises a first connection component adapted to be connected with a car status detection device and a second connection component adapted to be connected with a holding brake controller. The control unit is connected with the connection unit and is configured to perform various operations. For example, in one of the operations, an elevator emergency operation function is performed in a first configuration state in which the first connection component and the second connection component are connected with the car status detection device and the holding brake controller, respectively. As another example, in another operation, in the first configuration state, releasing a holding brake associated with the holding brake controller and determining whether a seal star function is normal based on a first car status signal provided by the car status detection device.

Optionally, in the elevator emergency operation device, the holding brake controller comprises a first holding brake controller and a second holding brake controller. Accordingly, the control unit is further configured to perform the following operations: in a second configuration state in which the first connection component is connected with the car status detection device and the second connection component is connected with the first holding brake controller, activating a first holding brake associated with the first holding brake controller and determining whether a function of the first holding brake is normal based on a second car status signal provided by the car status detection device, wherein the second car status signal is obtained when a second holding brake associated with the second holding brake controller is in a released state. Further, the control unit is further configured to perform the following operations: in a third configuration state in which the first connection component is connected with the car status detection device and the second connection component is connected with the second holding brake controller, activating the second holding brake and determining whether a function of the second holding brake is normal based on a third car status signal provided by the car status detection device, wherein the third car status signal is obtained when the first holding brake is in a released state.

Optionally, the control unit of the elevator emergency operation device comprises an input/output port, a central processing unit, a memory and a computer program stored on the memory. The input/output port comprises an input port connected with the first connection component to receive the first car status signal, the second car status signal and the third car status signal; and an output port connected with the second connection component to output a control command to the holding brake controller. The running of the computer program on the central processing unit causes various operations to be performed.

Optionally, in the elevator emergency operation device, the first car status signal, the second car status signal and the third car status signal are displacement signals of the car, and the car status detection device comprises an encoder for detecting displacement of the car.

Optionally, the elevator emergency operation device further comprises a plurality of buttons configured to generate, in response to an event that a set combination of the plurality of buttons is pressed, a trigger signal that causes the control unit to perform a corresponding type of the operation.

Optionally, the elevator emergency operation device further comprises a display component configured to present the type and result of the operation currently performed by the control unit.

Optionally, in the elevator emergency operation device, the control unit is configured to allow a single-armed release test operation to be performed only if it is determined that the seal star function is normal.

Optionally, in the elevator emergency operation device, an elevator emergency operation is performed in the following manner: determining a speed of the car based on the car status signal provided by the car status detection device; and activating or releasing the holding brake associated with the holding brake controller based on the speed of the car, causing the car to move to a desired position.

Optionally, in the elevator emergency operation device, a seal star function test operation is performed in the following manner: releasing the holding brake associated with the holding brake controller to move the car up or down a set distance; determining a speed of the car based on the first car status signal; and determining that the seal star function is normal if the speed of the car is less than or equal to a set threshold value during the car moving up or down the set distance, otherwise determining that the seal star function is abnormal.

Optionally, in the elevator emergency operation device, the single-armed release test operation is performed in the following manner: activating the first holding brake; determining an unloaded speed of the car based on the second car status signal obtained when the second holding brake is in the released state and the car is unloaded; determining whether the function of the first holding brake is normal based on the unloaded speed of the car; if the function is normal, then determining a rated speed of the car based on the second car status signal obtained when the second holding brake is in the released state and the car has a set load; and determining whether the function of the first holding brake is normal based on the rated speed of the car.

Optionally, in the elevator emergency operation device, the single-armed release test operation is also performed in the following manner: activating the second holding brake; determining an unloaded speed of the car based on the third car status signal obtained when the first holding brake is in the released state and the car is unloaded; determining whether the function of the second holding brake is normal based on the unloaded speed of the car; if the function is normal, then determining a rated speed of the car based on the third car status signal obtained when the first holding brake is in the released state and the car has a set load; and determining whether the function of the second holding brake is normal based on the rated speed of the car.

### BRIEF DESCRIPTION OF THE DRAWINGS

The above and/or other aspects and advantages of the present application will be clearer and more easily understood from the following description of various aspects in conjunction with the accompanying drawings, in which the same or similar units are denoted by the same reference numerals. The accompanying drawings include:

FIG. 1 shows a schematic block diagram of a typical elevator emergency operation (EMRO) device.

FIG. 2 shows the principle of implementing a seal star function within an elevator system.

FIG. 3 is a schematic block diagram of an elevator emergency operation device with safety function testing capability in accordance with some embodiments of the present application.

FIG. 4 is a schematic block diagram of a specific example of a control unit in the elevator emergency operation device shown in FIG. 3.

### DETAILED DESCRIPTION OF THE INVENTION

The present application is described more fully below with reference to the accompanying drawings, in which illustrative embodiments of the application are illustrated. However, the present application may be implemented in different forms and should not be construed as limited to the embodiments presented herein. The presented embodiments are intended to make the disclosure herein comprehensive and complete, so as to more comprehensively convey the protection scope of the application to those skilled in the art.

In this specification, terms such as “comprising” and “including” mean that in addition to units and steps that are directly and clearly stated in the specification and claims, the technical solution of the application does not exclude the presence of other units and steps that are not directly and clearly stated in the specification and claims.

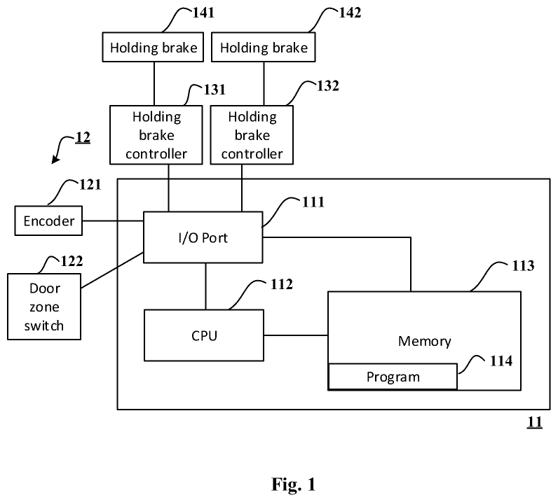

FIG. 1 shows a schematic block diagram of a typical elevator emergency operation (EMRO) device. A device 11 as shown in FIG. 1 includes an input/output port 111, a central processing unit 112, a memory 113 (for example a non-volatile memory such as a flash memory, a ROM, a hard drive, a disk, an optical disc), and a computer program 114 stored on the memory 113 and running on the central processing unit 112.

Referring to FIG. 1, the input/output port 111 (e.g., a network interface card) comprises an input port 111A configured to receive car status signals (e.g., a car position signal and an indication signal of the car reaching a door zone position, etc.) from a car status detection device 12. Exemplarily, the car status detection device 12 comprises an encoder 121 and a door zone switch 122. The encoder 121 may be an optical encoder or a magnetic encoder, etc., which is used to measure the position or displacement of the car and output a corresponding digital signal. The central processing unit 112 (e.g., a microprocessor) may determine a motion speed of the car based on the output signal of the encoder. The door zone switch 122 is used to detect whether the car is docked in the door zone to ensure that the car is aligned with a floor door when docked. As the car approaches the door zone switch, the door zone switch 122 will detect the position of the car and generates a corresponding trigger signal when the car reaches the door zone position.

As shown in FIG. 1, the input/output port 111 also comprises an output port 111B configured to output a control command, such as a command to activate or release a holding brake, to external devices (such as holding brake controllers 131 and 132). In performing an elevator emergency operation, the central processing unit 112 instructs the holding brake controllers 131 and 132 to release holding brakes 141 and 142 that are under their control (or associated with them), while at the same time it determines a speed of the car based on a car position signal provided by the encoder 121. If the speed of the car is less than a set threshold value, the central processing unit 112 instructs the holding brake controllers to put the holding brakes in a released state, otherwise, it instructs the holding brake controllers to activate the holding brakes to prevent the car from moving. Through the speed-based control mechanism described above, the central processing unit 112 causes the car to move to a desired floor, and after receiving an indication signal from the door zone switch 122 regarding the car reaching the door zone position, instructs the holding brake controllers to keep the holding brakes activated to ensure that the car stops at that floor.

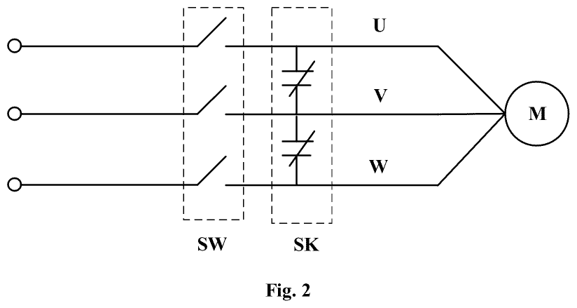

A seal star function is an important safety function of an elevator system. FIG. 2 shows the principle of implementing the seal star function within the elevator system. As shown in FIG. 2, a three-phase output of an inverter is connected with an elevator motor M via phase lines U, V and W. Switch SW and contactor SK are connected to the phase lines. During normal operation, when the car stops at the floor, the switch SW is disconnected and a contact of the contactor SK is closed, which causes the three phase lines U, V and W of the motor M to be short circuited to prevent the motor from sliding quickly, thus playing a safety protection role.

A holding brake function is another important safety function of the elevator system, which is often used for emergency braking and floor holding, etc. When the elevator system detects an emergency situation (e.g. abnormal elevator speed, power failure, door failure or other problems, etc.), the holding brake function will be triggered to quickly stop and brake the car. Also, for example, when the car reaches a destination floor, the holding brake function will be triggered to stop the car from moving and ensure that the car stops at that floor.

The holding brake function of the elevator may be performed by an electromagnetic brake or an electromagnetic holding brake. The electromagnetic brake comprises an electromagnetic coil (electromagnetic winding) and an iron core (holding brake iron core). When it is necessary to stop the motion of the car, the current flows into the electromagnetic coil, thereby generating a magnetic field in the coil, and under the action of the magnetic field, the iron core is attracted into the coil to prevent the motion of the car; when it is necessary to release the holding brake and restart the car, the current stops flowing through the coil, at which time the magnetic field disappears and the holding brake iron core is released. In the following description, the state in which the holding brake function of the holding brake can work is called the activated state, and the state in which the holding brake function of the holding brake does not work is called the released state.

Generally, in order to increase safety redundancy, the elevator system is equipped with a plurality of holding brakes to ensure that the holding brake function remains functional in the event of an emergency.

The seal star function and holding brake function are crucial parts related to the safety and reliability of elevator system, and as such, their design, operation and maintenance are strictly regulated by elevator safety standards and regulations. If the ability to test safety functions such as the seal star function and holding brake function can be integrated into the elevator emergency operation (EMRO) device, it will help improve the maintenance efficiency of the elevator system.

In some embodiments of the present application, the integration of the ability to test the seal star function and holding brake function into the elevator emergency operation device is realized by adding a connection unit to the elevator emergency operation device (e.g., the device shown in FIG. 1) and modifying the control logic. Since there is no need to substantially change the hardware structure of the existing elevator emergency operation device, it can accelerate development speed and reduce manufacturing costs. In addition, modifying the control logic does not involve changes to a human-machine interaction interface, which helps users to become familiar with and master the operation of the upgraded elevator emergency operation device in a short period of time.

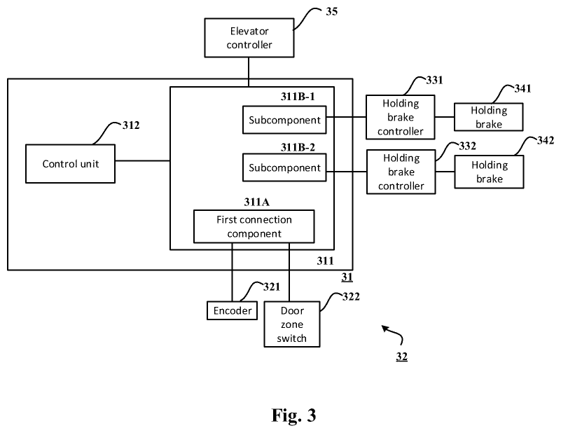

FIG. 3 is a schematic block diagram of an elevator emergency operation device with safety function testing capability in accordance with some embodiments of the present application. The device may be implemented using various control devices, such as including but not limited to a programmable logic controller, a remote terminal unit, an embedded control system, an industrial control computer, and so on.

A device 31 shown in FIG. 3 includes a connection unit 311 and a control unit 312 (e.g., a processor-based controller). The connection unit 311 may provide a connection between the control unit 312 and an external device (for example, a car status detection device 32 and holding brake controllers 331, 332, etc.). For example, when the elevator emergency operation device 31 is operating in an EMRO mode, the connection unit 311 provides a connection to the car status detection device (here, using an encoder 321 and a door zone switch 322 as an example) for the control unit 312. In addition, the connection unit 311 also establishes a connection between the control unit 312 and the holding brake controllers 331, 332.

Continuing to refer to FIG. 3, the connection unit 311 comprises a first connection component 311A and a second connection component 311B. In some embodiments, the first and second connection components provide a non-fixed connection between the control unit 312 and the external device, i.e., the connection components may connect the control unit 312 with the external device only if needed. Exemplarily, these connection components may take the form of connector assemblies, connectors, plugs and sockets, etc.

The first connection component 311A is adapted to connect the car status detection device 32 with the control unit 312 (i.e., connect the car status detection device 32 with the control unit 312 when the elevator emergency operation device is in the operating state); the second connection component 311B is adapted to connect the control unit 312 with the holding brake controllers 331, 332 (i.e., connect the holding brake controllers 331, 332 with the control unit 312 when the elevator emergency operation device is in the operating state). In some embodiments, the second connection component 311B may comprise a plurality of subcomponents, each subcomponent being capable of connecting the control unit 312 with one of the plurality of holding brake controllers, as desired. Using the scenario shown in FIG. 3 as an example, the second connection component 311B comprises two subcomponents 311B-1 and 311B-2, which may be connected with the holding brake controllers 331, 332, respectively, such that the control unit 312 is able to control the respective associated holding brakes 341 and 342 via the holding brake controllers 331, 332.

In some embodiments, the connection unit 311 may establish a connection between the control unit 312 and one or more of the holding brake controllers (e.g., the holding brake controllers 331, 332 of FIG. 3) associated with the plurality of holding brakes, as desired, such that the control unit 312 is able to control the state (activated state or released state) of a single holding brake or a group of holding brakes with the aid of the holding brake controllers.

In still other embodiments, an elevator controller 35 (e.g., a process-based controller) is also adapted to connect to the connection unit 311. In particular, the elevator controller 35 is able to be connected with either of the subcomponents 311B-1 and 311B-2, thereby implementing control over the state of one or all of the holding brakes 341 and 342 on the side of the elevator controller.

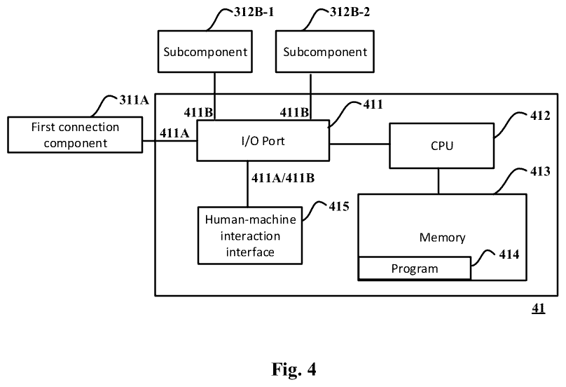

FIG. 4 is a schematic block diagram of a specific example of a control unit in the elevator emergency operation device shown in FIG. 3. A control unit 41 shown in FIG. 4 comprises an input/output port 411, a central processing unit 412, a memory 413 and a computer program 414 stored on the memory 413 and running on the central processing unit 412.

Referring to FIG. 4, the input/output port 411 comprises an input port 411A and an output port 411B connected with a connection unit (e.g., the connection unit 311 in FIG. 3). Using FIG. 3 as an example, the input port 411A may be connected to the first connection component 311A so as to be able to receive car status signals (e.g., a car position signal provided by the encoder and an indication signal of the car reaching the door zone position provided by the door zone switch, and so on) sent from a car status detection device (e.g., the device 32 in FIG. 3). The output port 411B may be connected to one or all of the subcomponents 311B-1 and 311B-2 so as to enable the central processing unit 412 to control the state of respective associated holding brakes with the aid of the holding brake controllers

By executing the computer program 414 by the central processing unit 412, the elevator emergency operation device may implement various control logics to accomplish an EMRO operation, a seal star function test operation, a single-armed release test operation, and the like. In some embodiments, integration of the seal star function test capability and the single-arm brake release test capability may be achieved by adding a seal star function test module and a single-arm brake release test module to the computer program of the elevator emergency operation device shown in FIG. 1. This upgrade method is advantageous in that existing EMRO function modules can be reused.

In some embodiments, the control unit 41 further comprises a human-machine interaction interface 415. In particular, the human-machine interaction interface 415 comprises a plurality of buttons (not shown) that may be provided on a surface of a housing of the elevator emergency operation device and electrically connected to the input port 411A. These buttons may form one or more combinations, each of which corresponds to one of the types of operation (e.g., operating modes to be described below). Therefore, when a combination of buttons is pressed, a trigger signal indicating the corresponding type of operation is input at the input port 411A. Subsequently, the central processing unit 412 performs the corresponding type of operation in response to this trigger signal.

In other embodiments, the human-machine interaction interface 415 further comprises a display component (e.g., a digital tube and an LED array, etc.). The display component may be provided on a surface of a housing of the elevator emergency operation device and electrically connected to the output port 411B. The display component may be configured to present the type of operation currently being performed by the control unit 312 and the result of the operation (e.g., the judgment results of normal or abnormal functions and the motion speed of the car, etc.).

In some embodiments, the elevator emergency operation device may operate in a variety of modes, including, for example, an EMRO mode, a seal star function test mode, and a single-armed release test mode, as further described with the aid of FIGS. 3 and 4 below.

### EMRO Mode

In the EMRO mode, the control unit 312 or the central processing unit 412 is connected with the car status detection device 32 via the first connection component 311A, and is connected with the holding brake controllers 331, 332 via subcomponents 312B-1 and 312B-2 of a second connection component 312B, respectively. In this configuration state, the control unit 312 will perform the elevator emergency operation function based on the corresponding control logic, such as determining the speed of the car based on the car position signal provided by the encoder 321, activating or releasing the holding brakes 341 and 342 based on the speed of the car, causing the car to move to a desired position, and after receiving the indication signal from the door zone switch 322 regarding the car reaching the door zone position, keeping the holding brakes 341 and 342 activated, and the like.

### Seal Star Function Test Mode

In the seal star function test mode, the control unit 312 or the central processing unit 412 is still connected with the car status detection device 32 via the first connection component 311A, and is connected with the holding brake controllers 331, 332 via the subcomponents 312B-1 and 312B-2 of the second connection component 312B, respectively. In this configuration state, the control unit 312 instructs the holding brake controllers 331, 332 to release the respective associated holding brakes 341 and 342, and determines whether the seal star function is normal based on the car status signal provided by the car status detection device 32.

In some embodiments, based on the instruction of the control unit 312, the holding brake controllers 331 and 332 release the respective associated holding brakes 341 and 342, at which time the car will move up or down; the control unit 312 or the central processing unit 412 then determines, for example, a distance and speed of car motion based on the car position signal provided by the encoder 321; and the control unit 312 or the central processing unit 412 determines whether the speed of the car is less than or equal to a set threshold value (e.g., 0.3 m/s) during the car moving up or down a set distance (e.g., 1.2 m), and if it is less than or equal to the threshold value, it is determined that the seal star function is normal, otherwise, it is determined that the seal star function is abnormal.

### Single-Armed Release Test Mode

In the single-armed release test mode, the control unit 312 or the central processing unit 412 is connected with the car status detection device 32 via the first connection component 311A, and is connected with the holding brake controller 331 via the subcomponent 312B-1 of the second connection component 312B. On the other hand, similar to the normal operation, the holding brake controller 332 is still connected to the elevator controller or elevator control cabinet 35.

In the configuration state described above, the control unit 312 may cooperate with the elevator controller 35 to test the function of the holding brake 341 under various conditions. For example, during the test of the car being unloaded, under the control of the elevator controller 35, the holding brake 342 is in the released state and the central processing unit 412 activates the holding brake 341 with the aid of the holding brake controller 331. At this time, an unloaded speed of the car may be determined based on the car status signal (e.g., the car position signal) from the car status detection device 32, and whether the function of the holding brake 341 is normal is determined based on the unloaded speed. For example, if the unloaded speed is greater than 0, it is determined that the function of the holding brake 341 is abnormal, otherwise, a subsequent test process is performed. In an exemplary subsequent test process, the car is loaded with a set load, the holding brake 341 is in an activated state and the holding brake 342 is in a released state. At this time, a rated speed of the car may be determined based on the car status signal (e.g., the car position signal) from the car status detection device 32, and whether the function of the holding brake 341 is normal is determined based on the rated speed. For example, if the rated speed exceeds a set multiple of a rated speed, it is determined that the function of the holding brake 341 is abnormal, otherwise, it is determined that the function of the holding brake 341 is normal.

After completing the single-arm brake release test on the holding brake 341, the single-arm brake release test may be performed on the holding brake 342. In order to complete the test on the holding brake 342, the control unit 312 or the central processing unit 412 is connected with the car status detection device 32 via the first connection component 311A, and is connected with the holding brake controller 332 via the subcomponent 312B-2 of the second connection component 312B. At the same time, the holding brake controller 331 is connected to the elevator controller or elevator control cabinet 35. Accordingly, in this test, the holding brake 341 is in the released state and the holding brake 342 is in the activated state, and the control unit 312 may determine whether the function of the holding brake 342 is normal based on the unloaded speed and the rated speed of the car.

In some embodiments, the single-armed release test mode is run only if the seal star function is determined to be normal in the seal star function test.

Those skilled in the art will appreciate that various illustrative logical blocks, modules, circuits, and algorithm steps described herein may be implemented as electronic hardware, computer software, or combinations of both.

To demonstrate this interchangeability between the hardware and software, various illustrative components, blocks, modules, circuits, and steps have been described above generally in terms of their functionality. Whether such functionality is implemented in hardware or software depends on the particular application and design constraints imposed on the overall system. Those skilled in the art may implement the described functionality in changing ways for the particular application. However, such implementation decisions should not be interpreted as causing a departure from the scope of the present application.

Although only a few of the specific embodiments of the present application have been described, those skilled in the art will appreciate that the present application may be embodied in many other forms without departing from the spirit and scope thereof. Accordingly, the examples and implementations shown are to be regarded as illustrative and not restrictive, and various modifications and substitutions may be covered by the application without departing from the spirit and scope of the application as defined by the appended claims.

The embodiments and examples presented herein are provided to best illustrate embodiments in accordance with the present technology and its particular application, and to thereby enable those skilled in the art to implement and use the present application. However, those skilled in the art will appreciate that the above description and examples are provided for convenience of illustration and example only. The presented description is not intended to cover every aspect of the application or to limit the application to the precise form disclosed.

What is claimed is:

1. An elevator emergency operation device with safety function testing capability, comprising:
a connection unit comprising a first connection component adapted to be connected with a car status detection device and a second connection component adapted to be connected with a holding brake controller; and
a control unit connected with the connection unit and configured to perform the following operations:
A. in a first configuration state in which the first connection component and the second connection component are connected with the car status detection device and the holding brake controller respectively, performing an elevator emergency operation function;
B. in the first configuration state, releasing a holding brake associated with the holding brake controller and determining whether a seal star function is normal based on a first car status signal provided by the car status detection device.

2. The elevator emergency operation device of claim 1, wherein the holding brake controller comprises a first holding brake controller and a second holding brake controller, the control unit is further configured to perform the following operations:
C. in a second configuration state in which the first connection component is connected with the car status detection device and the second connection component is connected with the first holding brake controller, activating a first holding brake associated with the first holding brake controller and determining whether a function of the first holding brake is normal based on a second car status signal provided by the car status detection device, wherein the second car status signal is obtained when a second holding brake associated with the second holding brake controller is in a released state.

3. The elevator emergency operation device of claim 2, wherein the control unit is further configured to perform the following operations:
D. in a third configuration state in which the first connection component is connected with the car status detection device and the second connection component is connected with the second holding brake controller, activating the second holding brake and determining whether a function of the second holding brake is normal based on a third car status signal provided by the car status detection device, wherein the third car status signal is obtained when the first holding brake is in a released state.

4. The elevator emergency operation device of claim 3, wherein the control unit comprises:
an input/output port comprising:
an input port connected with the first connection component to receive the first car status signal, the second car status signal and the third car status signal;
an output port connected with the second connection component to output a control command to the holding brake controller;
a central processing unit;
a memory; and
a computer program stored on the memory and running on the central processing unit, the running of the computer program causes operations A, B, C and D to be performed.

5. The elevator emergency operation device of claim 3, wherein the first car status signal, the second car status signal and the third car status signal are displacement signals of the car, and the car status detection device comprises an encoder for detecting displacement of the car.

6. The elevator emergency operation device of claim 3, wherein the elevator emergency operation device further comprises a plurality of buttons configured to generate, in response to an event that a set combination of the plurality of buttons is pressed, a trigger signal that causes the control unit to perform a corresponding type of the operations.

7. The elevator emergency operation device of claim 1, wherein the elevator emergency operation device further comprises a display component configured to present type and result of the operations currently performed by the control unit.

8. The elevator emergency operation device of claim 3, wherein the control unit is configured to allow the operations C and D to be performed only if it is determined that the seal star function is normal.

9. The elevator emergency operation device of claim 1, wherein the operation A comprises:
determining a speed of the car based on the car status signal provided by the car status detection device; and
activating or releasing the holding brake associated with the holding brake controller based on the speed of the car, causing the car to move to a desired position.

10. The elevator emergency operation device of claim 1, wherein the operation B comprises:
releasing the holding brake associated with the holding brake controller to move the car up or down a set distance;
determining a speed of the car based on the first car status signal; and
determining that the seal star function is normal if the speed of the car is less than or equal to a set threshold value during the car moving up or down the set distance, otherwise determining that the seal star function is abnormal.

11. The elevator emergency operation device of claim 2, wherein the operation C comprises:
activating the first holding brake;
determining an unloaded speed of the car based on the second car status signal obtained when the second holding brake is in the released state and the car is unloaded;
determining whether the function of the first holding brake is normal based on the unloaded speed of the car;
if the function of the first holding brake is normal, then determining a rated speed of the car based on the second car status signal obtained when the second holding brake is in the released state and the car has a set load; and
determining whether the function of the first holding brake is normal based on the rated speed of the car.

12. The elevator emergency operation device of claim 3, wherein the operation D comprises:
activating the second holding brake;
determining an unloaded speed of the car based on the third car status signal obtained when the first holding brake is in the released state and the car is unloaded;
determining whether the function of the second holding brake is normal based on the unloaded speed of the car;
if the function of the second holding brake is normal, then determining a rated speed of the car based on the third car status signal obtained when the first holding brake is in the released state and the car has a set load; and
determining whether the function of the second holding brake is normal based on the rated speed of the car.
